(19) United States
(12) Patent Application Publication
(10) Pub. No.: US 2018/0357303 A1
(43) Pub. Date: Dec. 13, 2018

(54) DETERMINING FEATURE SCORES FOR MESSAGE FEATURES

(71) Applicant: Google Inc., Mountain View, CA (US)

(72) Inventors: Andrew Tomkins, Menlo Park, CA (US); Shanmugasundaram Ravikumar, Berkeley, CA (US); Shalini Agarwal, San Francisco, CA (US); MyLinh Yang, Saratoga, CA (US); Bo Pang, Sunnyvale, CA (US); Mark Yinan Li, San Francisco, CA (US)

(21) Appl. No.: 15/423,306

(22) Filed: Feb. 2, 2017

Related U.S. Application Data
(63) Continuation of application No. 14/145,333, filed on Dec. 31, 2013, now abandoned.

(51) Int. Cl. G06F 17/30

(52) U.S. Cl. CPC G06F 17/30687

(57) ABSTRACT

Methods and apparatus related to determining feature scores for message features. An electronic message associated with at least one user and associated with an event may be identified. A likelihood that the at least one user interacted with the event may be identified. One or more message features of the electronic message may be determined. Based on the likelihood that the at least one user interacted with the event, a feature score may be associated with a given message feature of the one or more message features, where the feature score is indicative of a likelihood that the at least one user will interact with another event associated with another message having the given message feature. The feature score may be associated with the given message feature.

### BACKGROUND

An electronic message may be associated with a user and an event. The electronic message may include one or more message features related to the event.

### SUMMARY

The present disclosure is generally directed to methods and apparatus related to determining feature scores for message features. An electronic message associated with at least one user and associated with an event may be identified. A likelihood that the at least one user interacted with the event may be identified. One or more message features of the electronic message may be determined. Based on the likelihood that the at least one user interacted with the event, a feature score may be associated with a given message feature of the one or more message features, where the feature score is indicative of a likelihood that the at least one user will interact with another event associated with another message having the given message feature. The feature score may be associated with the given message feature.

Some implementations are directed to associating a component weight with one or more components of a feature representation of the electronic message, and determining the feature score based on the component weight. Some implementations are directed to utilizing feature scores associated with message features to determine the likelihood that the user will interact with an additional event associated with an additional message.

In some implementations a computer implemented method may be provided that includes the steps of: identifying an electronic message associated with at least one user and associated with an event; identifying a likelihood that the at least one user interacted with the event; determining one or more message features of the electronic message; determining, based on the likelihood that the at least one user interacted with the event, a feature score for a given message feature of the one or more message features, wherein the feature score indicative of a likelihood that the at least one user will interact with another event associated with another message having the given message feature; and associating the feature score with the given message feature.

This method and other implementations of technology disclosed herein may each optionally include one or more of the following features.

In some implementations determining the one or more message features may include generating a feature representation based on the message feature. The method may further include associating a component weight with one or more components of the feature representation, where determining the feature score may be based on the component weight.

In some implementations the method may further include determining the event attribute of the event. In some implementations the event attribute may be a collection of additional users. In some implementations determining the one or more message features may be based on the event attribute.

In some implementations determining the one or more message features may further include determining one or more n-grams from the message.

In some implementations the at least one user may be a collection of users.

The method may further include identifying an additional message of the at least one user, the additional message including an additional event and an additional message feature; matching the additional message feature to the given message feature; and determining a likelihood that the at least one user will interact with the additional event based on the feature score associated with the given message feature. In some implementations the method may further include providing content related to the additional event based on the likelihood that the at least one user will interact with the additional event. In some implementations providing the content may include providing an indication to the at least one user that the additional message pertains to an event.

In some implementations identifying the electronic message may include identifying a group of electronic messages.

In some implementations the electronic message may be generated by the at least one user.

Other implementations may include a non-transitory computer readable storage medium storing instructions executable by a processor to perform a method such as one or more of the methods described herein. Yet another implementation may include a system including memory and one or more processors operable to execute instructions, stored in the memory, to perform a method such as one or more of the methods described herein.

Particular implementations of the subject matter described herein may identify an event attribute associated with an electronic message. Particular implementations of the subject matter described herein may determine one or more message features of the electronic message, and associate features scores with the one or more message features. Associating, with a message feature, a feature score indicative of a likelihood that the at least one user will interact with another event associated with another message having a given message feature presents a new aspect of the electronic message.

It should be appreciated that all combinations of the foregoing concepts and additional concepts discussed in greater detail herein are contemplated as being part of the subject matter disclosed herein. For example, all combinations of claimed subject matter appearing at the end of this disclosure are contemplated as being part of the subject matter disclosed herein.

### BRIEF DESCRIPTION OF THE DRAWINGS

FIG. 1 is a block diagram of an example environment in which feature scores for message features are determined.

FIG. 2A is a schematic diagram of an example group of electronic messages.

FIG. 2B is a table illustrating one example of message features and event attributes associated with an electronic message.

FIG. 2C is a table illustrating an example message and n-grams associated with the message.

FIG. 2D is a table illustrating another example message and n-grams associated with the message.

FIG. 3 is a flow chart illustrating an example method of determining feature scores for message features.

FIG. 4 illustrates a block diagram of an example computer system.

### DETAILED DESCRIPTION

Technology described herein is useful in determining feature scores for message features. For example, the user may receive an electronic message such as “Shakespeare in the park this Saturday?”, and respond with an electronic message such as “Be there at 7”. An event such as “Shakespeare in the park” may be identified. Event attributes may be identified, the event attributes identifying one or more characteristics of the event, including an event location, invitees, potential attendees, actual attendees, performers, day, date, time, reviews, dress code, and so forth.

One or more message features may be determined from the electronic messages. The one or more message features represent aspects of the electronic message, including identifiers for a sender, recipient, timestamp data, metadata, processed features (e.g., via language processing), event attributes included in the message, n-grams in the message, data related to electronic transmission of the message (e.g., how many times the message is forwarded and to whom, the number of messages in a message trail to which the message belongs), and so forth. For example, terms such as “park”, “Shakespeare”, a 4-gram such as “Shakespeare in the park”, and 2-grams such as “this Saturday”, “Be there”, “at 7”, and so forth may be determined. Also, for example, the one or more message features may be combined, such as “Shakespeare this Saturday”, “Shakespeare at 7”, “park this Saturday”, “park at 7”, and so forth.

One or more feature representations may be generated based on the one or more message features, and/or the event attribute. One or more databases may be accessed to retrieve information related to whether the user went to “Shakespeare in the park”. A feature score may be associated with each of the one or more message features, where the feature score is based on the likelihood that the user interacted with the event “Shakespeare in the park”. A feature score for a given message feature of the one or more message features is indicative of a likelihood that the user will interact with another event associated with another message having the given message feature. For example, a given message feature “Shakespeare in the park, at 7” may be associated with a high likelihood that the user will interact with another event associated with another message having the given message feature. Such associations may be stored in one or more databases.

At a future time, the user may receive another electronic message such as “Shakespeare in the park next Friday?”, and respond with an electronic message such as “at 6”. An additional event “Shakespeare in the park” may be identified and an additional message feature “Shakespeare in the park, at 6” may be matched to the given feature message “Shakespeare in the park, at 7”. Based on the feature score associated with the given message feature “Shakespeare in the park, at 7”, it may be determined that the user is likely to go to “Shakespeare in the park next Friday at 6”.

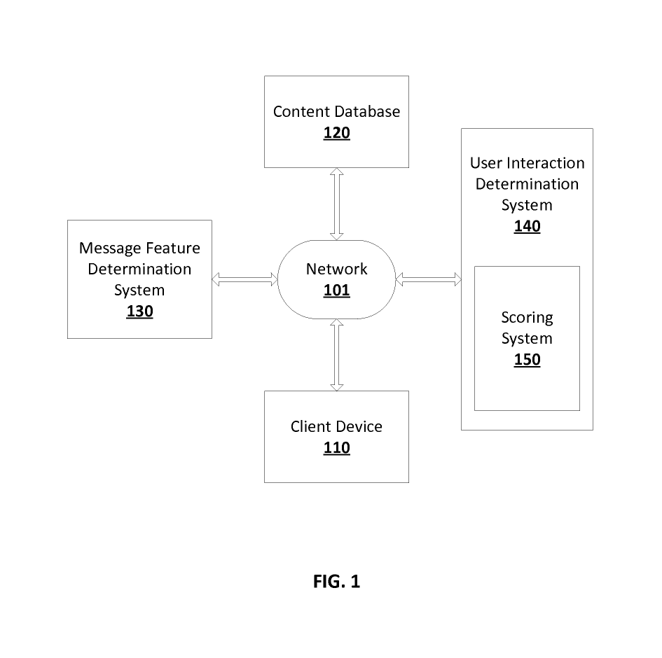

FIG. 1 illustrates a block diagram of an example environment in which feature scores for message features are determined. The example environment includes a communication network 101 that facilitates communication between the various components in the environment. In some implementations the communication network 101 may include the Internet, one or more intranets, and/or one or more bus subsystems. The communication network 101 may optionally utilize one or more standard communications technologies, protocols, and/or inter-process communication techniques. The example environment may also include a client device 110, a content database 120, a message feature determination system 130, a user interaction determination system 140, and a scoring system 150. Many other configurations are possible having more or fewer components than the environment shown in FIG. 1.

The client device 110 may execute one or more applications, such as a web browser. The client device 110 may be, for example, a desktop computer, a laptop, a mobile phone, a computing device of a vehicle of the user (e.g., an in-vehicle communications system, an in-vehicle entertainment system, an in-vehicle navigation system), a wearable apparatus of the user that includes a computing device (e.g., a watch having a computing device, glasses having a computing device). Additional and/or alternative computing devices may be provided.

In some implementations at least one user may be identified. For example, the message feature determination system 130 may identify the user based on a user identification that identifies the user either specifically or generally. For example, the user identification may be an IP address, a geographic region, and/or other information stored in a cookie that is submitted with and/or included with data provided by the client device 110 and/or other component (e.g., an email service). Also, for example, a user may, via client device 110, utilize user credentials to log in to a service (e.g., an email service) and user data that is associated with the service may be provided via client device 110.

In some implementations the at least one user may be a collection of users. For example, the collection of users may be identified as users with ages in a given geographical area (e.g., zipcode, state, region), users sharing a common profession (e.g., professors, attorneys, journalists, farmers, truck drivers), users sharing similar hobbies and/or interests (e.g., viewers of “Big Bang Theory”, shoppers at Tiffany's, hikers), and so forth.

An electronic message associated with the at least one user and associated with an event may be identified. The electronic message may include one or more of email communications, posts on social networking platforms, instant messages, chats, message board postings, social media postings, and so forth. In some implementations the message feature determination system 130 identifies the electronic message. In some implementations a group of electronic messages may be identified. In some of those implementations the group of electronic messages is a grouping of related messages. In some implementations, the group of electronic messages may be identified by determining associations between the messages of the group such as the messages being part of the same thread, the messages sharing similar recipients, the messages being generated by an individual and sent to one or more similar individuals, the messages having similar subject lines, the messages having similar terms in bodies of the messages, and/or a relationship of the messages to a task and/or an event. In some implementations, the group of electronic messages may be a linear continuation of messages between two or more users.

In some implementations, the group of electronic messages may include one or more messages that are sent and/or received by the user and sent and/or received by one or more additional users. For example, User 1 may send a message to User 2 and User 3, both of which may independently reply to the message from User 1. Also, for example, User 2 may reply to the message by sending a reply message to both User 1 and User 3. Also, for example, User 2 may send a related message to User 3 and not to User 1. For example, at least one user may exchange one or more messages with at least one additional user, where the one or more messages are associated with an event. For example, the at least one user may exchange one or more emails with “John” and “Julie” related to attending an awards ceremony. The message feature determination system 130 may identify the one or more emails as a group of electronic messages associated with the event to “attend an awards ceremony”.

In some implementations, the group of electronic messages may include one or more electronic messages that may be associated with an event based on a user indication such as, for example, the at least one user associating an event entry in a calendar and/or other application with the one or more electronic messages. For example, the at least one user may create the event entry from the one or more electronic messages or otherwise associate the message with the event entry. Also, for example, the message feature determination system 130 may determine that each of the messages of the one or more electronic messages is associated with one or more events as described herein.

In some implementations the messages may be identified, for example, from the content database 120 and/or other component such as a database maintained by a messaging system such as an email database. As another example, the at least one user may exchange one or more messages with a collection of users (e.g., friends, alumni, family, and business associates) and the message feature determination system 130 may identify the one or more messages as the group of electronic messages based on the collection of users. Also, for example, the at least one user may exchange one or more messages that share a common subject, for example, “Shakespeare in the park”, “Light up Louisville”, “Awards Ceremony”, and the message feature determination system 130 may identify the one or more messages as the group of electronic messages associated with the events “Shakespeare in the park”, “Light up Louisville”, “Awards Ceremony”, respectively.

In some implementations techniques such as contextual analysis, feature determination, parse trees, and so forth may be utilized to identify common entities and/or concepts in the electronic messages, the electronic messages may be indexed based on such common entities and/or concepts, and the group of electronic messages identified based on such an index. In some implementations one or more of the electronic messages may not be generated by the at least one user. For example, the at least one user may receive one or more messages from additional users. In some implementations the group of electronic messages associated with the at least one user may include electronic messages generated by the at least one user. For example, the at least one user may send an invitation to an event. As another example, the at least one user may respond to an invitation to an event. In some implementations the message may not be generated by the user. For example, the user may be a recipient of one or more messages, and may not respond to any of the one or more messages.

For each identified electronic message, one or more event attributes of the event may be determined. One or more natural language processing techniques may be optionally utilized to identify the one or more event attributes from the message. For example, the group of electronic messages may be identified as a group of emails that share the subject “Awards Ceremony”. The message feature determination system 130 may identify the term “Awards Ceremony” in the subject and the term “White House” in the body of the electronic message. Based at least in part on the user identification, and the terms “Awards Ceremony” and “White House”, the message feature determination system 130 may access a database such as content database 120 to determine that an awards ceremony for software engineers is scheduled for Friday at the White House. For example, the content database 120 may include an event database including a list of events that are scheduled, and such a list may be additionally annotated with entities associated with the event (e.g., awardees, invitees, performers, physical location of the event, sponsors, organizers, ticket agencies), and dates and times of the events.

In some implementations the event attributes may include, for example, an event location, invitees to the event, likely visitors to the event location, a date of the event, a time of the event, a dress code for the event, and/or a type of event. For example, the type of event may be a “game day” at an event location characterized as a “sports bar”, with invitees including “college alumni”, and a dress code for the event may be “college colors”. As another example, the type of event may be a “hiking” at an event location identified as “Mt. ABC”, and a dress code for the event may be identified as “hiking attire”. Also, for example, the type of event may be a “field trip” at an event location identified as the “zoo”, and a dress code for the event may be identified as “winter jackets, caps, and gloves”.

In some implementations the event attributes may include an event location identifier. For example, an event location identifier may include one or more of a physical address of the event location, name of the event location (e.g., Spinachilini's), telephone number associated with the event location, GPS coordinates associated with the event location, broadcast name for a Wi-Fi network associated with the event location, and so forth.

In some implementations determining the event location identifier of the event attributes may be based on the group of electronic messages. For example, the user may be planning an event via the group of electronic messages and the event location identifier may be included in one or more of the electronic messages. In some implementations the message feature determination system 130 may identify one or more entities appearing in the group of email messages and utilize the one or more entities to identify an event location identifier. For example, one or more of the electronic messages may include the term “Spinachilini's”, and the message feature determination system 130 may identify the entity associated with “Spinachilini's” as an event location identifier.

In some implementations the event database may include a database of structured data, such as an event graph, that includes nodes that represent events and identifies the event attributes represented by a node. A node representing an event may also be associated with metadata in the database of structured data (e.g., via links that represent event attributes). Any included metadata may include, for example, names/aliases for the event and/or event location, resources related to the event, descriptive information about the event, among other data. The event database may include location data for each of one or more event locations (e.g., museum, theater, concert hall, basketball arena, restaurant, etc.). For example, content database 120 may include location data that is associated with an event location. The information about the event location may include an identifier of the event location such as an address, a latitude and longitude, a zip code, a neighborhood, and/or other identifier. In some implementations the event attributes in the event database may be explicitly indicated as event location identifiers in the event database.

In some implementations an entity database may be utilized to identify one or more entities that appear in the electronic message. An entity database may include, for each of a plurality of entities, a mapping (e.g., data defining an association) between the entity and one or more characteristics of the entity and/or other entities related to the entity. In some implementations, entities are topics of discourse. In some implementations, entities are persons, places, concepts, and/or things that can be referred to by a textual representation (e.g., a term or phrase) and are distinguishable from one another (e.g., based on context). In some implementations the entity database may be included in the content database 120. In this specification, the term “database” will be used broadly to refer to any collection of data. The data of the database does not need to be structured in any particular way, or structured at all, and it can be stored on storage devices in one or more geographic locations. Thus, for example, the content database 120 may include multiple collections of data, each of which may be organized and accessed differently.

As disclosed herein, in some implementations the message feature determination system 130 may identify the group of electronic messages, and utilize an entity database to identify the one or more event attributes associated with the group of electronic messages. In some implementations the event attributes may be identified from the electronic messages of the group of electronic messages. For example, electronic messages may include a time, a date, and a location, and these may be identified as the event attributes. In some implementations the time of the event may be indirectly determined based on the email messages. For example, the email message may be sent on Friday, January 1, and may include the term “this Saturday”. Based at least in part on such data, the message feature determination system 130 may determine that the awards ceremony is scheduled for Saturday, January 2.

In some implementations the event attributes may include a collection of additional users. For example, the collection of additional users in a group of email messages associated with the event may be identified based on the identifiers in the email meta data fields, such as fields associated with “To”, “Cc”, and “Bcc” in the group of email messages. Also, for example, the user may exchange an instant message with “Bob” related to a dinner at Restaurant A. The message feature determination system 130 may identify “Bob” as an additional user associated with the event.

A likelihood that the at least one user interacted with the event may be determined. In some implementations the user interaction determination system 140 may access a database such as content database 120 to retrieve information related to the likelihood that the user interacted with the event in the past. For example, a stored entry in a database and/or index personal to the user may map a likelihood that the user interacted with the event. For example, the entry may include a determined probability the user interacted with Restaurant A, a status identifier indicating the user interacted with Restaurant A, and/or other identifier indicating the entry is related to a location likely interacted with by the user. Based on conventional and/or other searching techniques, the stored entry may be determined to be relevant to the user. For example, the content database 120 may include an entry associated with the user and the event. For example, an entry associated with the user may include an identifier of the likelihood and an identifier of at least one of the event attributes associated with the event. For example, in implementations where the likelihood is a binary “true” or “false”, the entry may include an identifier of the likelihood that indicates an event location was visited by the user.

In some implementations the content database 120 may include an event database that includes structured data, such as an event graph, that includes nodes that represent events and identifies the one or more event attributes represented by a node. In some implementations an event may be associated with the user, and/or the one or more event attributes. In some implementations such associations may be additionally annotated with the respective likelihoods. In some implementations the stored associations may be specific to the user. For example, the associations between the user, the one or more event attributes, and the likelihood that the user interacted with the event location and/or one or more event attributes may be stored in a database with access restrictions that only enable access by the user and/or one or more other users authorized by the user.

In some implementations the user interaction determination system 140 may compare location data of the at least one user to event location identifiers to determine the likelihood that the user interacted with the one or more event attributes. The determined likelihood may be binary, non-binary, may be based on time duration associated with the respective location data, the number of matches between the respective location data, a weighting of the respective location data, and so forth. The term “match” as used herein, includes exact matching and/or soft matching. For example, the user interaction determination system 140 may match n-grams of event location identifiers and location data of the user by stemming one or more terms of the n-grams, rearranging terms of the n-grams, etc. Also, for example, the user interaction determination system 140 may determine an event location identifier and a location data of a user match if they are within a threshold distance of one another. Additional and/or alternative techniques may be utilized to determine the likelihood that the user interacted with the one or more event attributes. For example, location data of the user may be compared to the location data of the one or more additional users to determine the likelihood that the user interacted with the one or more additional users.

One or more message features may be determined from the electronic message. The message features may be determined from, for example, a subject line of the message, a body of the message, recipient fields of the message, hyperlinks of the message, metadata of the message, and/or one or more additional or alternate components of a message. The message features of the electronic message may include some or all of the content of the electronic message, and/or any information that may be derived from the content of the message. For example, the one or more message features of the electronic message may include but are not limited to: words, terms or phrases in the electronic message; URLs in the electronic message; number of URLs in the electronic message; timestamps of the electronic message; a user's interest (or lack of interest) in topics or subjects based on content of the electronic message; whether the content of the electronic message is spam; and/or any other information based on content analysis of the messages. For example, the body of the messages may be processed by another module to identify topics of interest and/or topics not interesting to the user. As described herein, the message feature determination system 130 processes the content of the electronic message to generate signals, and the user interaction determination system 140 utilizes the signals to determine the feature scores of feature representations.

The message features may additionally and/or alternatively include user interaction data, including possible timestamp data, related to whether the message was opened, read, forwarded, responded to, categorized or stored in a particular location, deleted, removed and/or deleted without review by an automated program (e.g., a spam filter). Additional and/or alternate user interaction data may include recency of interaction with the message, quickness of response or processing of messages from a particular user or on a particular topic, frequency of interaction with messages on the same topic or from a user or group of users, whether the user has interacted with the user or the group of users before (e.g., at all, frequently, replied once, etc.), whether the user only received messages but did not reply and/or infrequently replies (e.g., to advertising) or other interactions with electronic messages. The message feature determination system 130 may utilize the user interaction data to provide signals to the user interaction determination system 140 to determine the feature score of a feature representation.

In some implementations determining the one or more message features may include determining one or more n-grams from the message. An n-gram is a sequence of n consecutive terms appearing in a text segment. For example, the message may include a sentence: “Are we going to the Awards Ceremony?”. The n-grams in the sentence may be identified as “Are we”, “going”, “going to”, “Awards Ceremony”, “going to the Awards Ceremony”, “Are we going to the Awards Ceremony?”, and so forth. Also, for example, the message may include a sentence: “Lets do it!”. The n-grams in the sentence may be identified as “Lets”, “do”, “it”, “Lets do”, “do it”, “Lets do it”, and “Lets do it!”.

In some implementations canonicalized versions of terms and/or phrases appearing in the electronic message may be utilized to determine the message features. For example, the terms and/or phrases could be stemmed and their stop words removed. Stop words include words that are common and may include articles such as “a”, “an,” “and,” and “the”; prepositions such as “of,” “to” and “for”; auxiliary verbs such as “have” and “were”; and/or typical initial words in questions such as “who”, “how” and “where”. White space and/or other identified “noise” features (e.g., features determined to be unlikely to have any distinguishing properties) may be removed. For example, commercial content and/or other content unrelated to the event attribute and/or the at least one user may be removed from the given electronic message.

In some implementations one or more text segments in the electronic message may be parsed to determine the message features. For example, a text segment may be fragmented into sentences and/or parts thereof. One or more natural language processing techniques may be optionally utilized to fragment a text segment into parts that identify at least a portion of an event attribute. For example, keywords and/or key phrases may be identified along with their parts of speech. A parse tree may be determined that links keywords and/or phrases in one or more sentences based on their syntactic and/or semantic relationships. In some implementations a context-free grammar may be utilized to structure a sentence from the parse tree, and determine the one or more message features based on the structured sentence.

In some implementations determining the one or more message features may include generating a feature representation of a given message feature of the one or more message features. The feature representation may be indicative of one or more features of the message feature, including one or more of relationships of one or more terms in the message feature, relationships of terms in the message feature with one or more terms not in the message feature, relevance of the message feature to the electronic message, entities occurring in the message feature, a task and/or an event related to the message feature, and so forth. For example, the feature representation may include syntactic and semantic features between terms (e.g., key words and key phrases, synonyms, antonyms, hypernyms) of the given message feature. Syntactic features may include syntactic configurations and constraints that may influence contextual analysis of the given message feature in relation to the electronic message and/or the one or more message features. Semantic features may include domain features, such as semantic agreement between one or more message features. In some implementations such features may depend on one or more semantic resources, such as unsupervised distributional models that may measure semantic compatibility between two terms, and/or phrases in the electronic message. In some implementations the message feature determination system 130 may access the content database 120 to retrieve stored feature representations for the one or more message features in the content database 120. For example, feature representations may be determined using one or more models, and the feature representations and associated models may be stored in the content database 120.

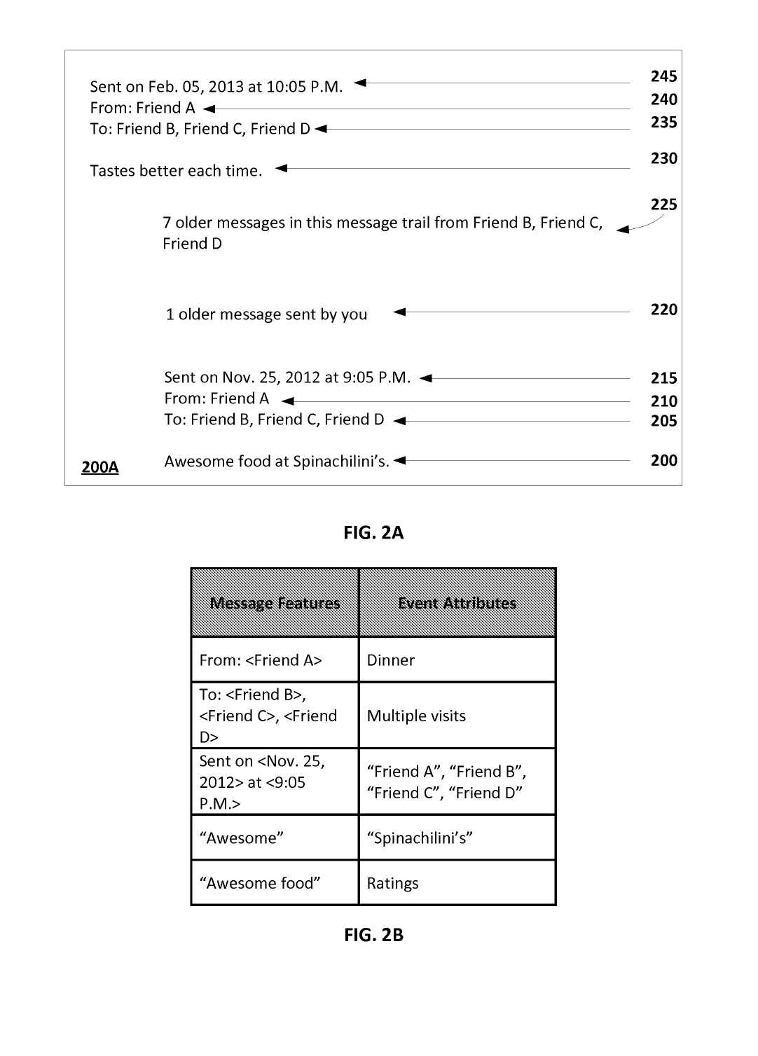

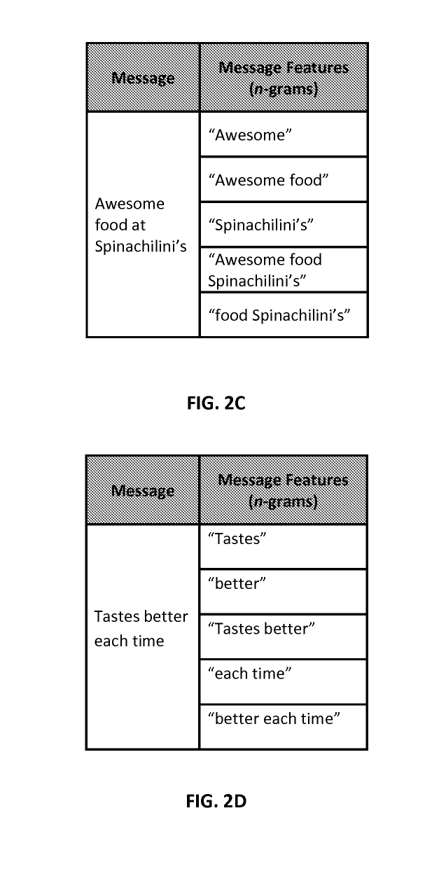

Referring to FIG. 2A, a schematic diagram of an example group of electronic messages is illustrated. A group of electronic messages 200A is illustrated. The content of a first message is illustrated by a first text segment 200 that states “Awesome food at Spinachilini's”. The “To” field 205 of the first message indicates that Friend B, Friend C, and Friend D are the recipients of the first message. The “From” field 210 of the first message indicates that Friend A is the sender of the first message. Time stamp data 215 for the first message indicates that the first message was sent on Nov. 25, 2012 at 9:05 P.M. In some implementations an email application may generate a message 220 such as “1 older message sent by you” identifying an earlier message sent by Friend A. In some implementations the email application may generate a message 225 such as “7 older message in this message trail from Friend B, Friend C, and Friend D” identifying earlier messages sent by Friend B, Friend C, and Friend D. As described herein, the group of messages may be identified via one or more techniques. In this example, the group of messages may be identified, for example, based on an exchange related to the food and/or experience at a restaurant, among a group of common friends, Friend A, Friend B, Friend C, and Friend D.

The content of a second message is illustrated by a second text segment 230 that states “Tastes better each time”. The “To” field 235 of the second message indicates that Friend B, Friend C, and Friend D are the recipients of the second message. The “From” field 240 of the second message indicates that Friend A is the sender of the second message. Time stamp data 245 for the second message indicates that the second message was sent on Feb. 5, 2013 at 10:05 P.M.

Referring to FIG. 2B, a table illustrates example of message features and event attributes associated with an electronic message. Some aspects of the example in FIG. 2B may be described with reference to the group of electronic messages illustrated in FIG. 2A. The message features and event attributes may be identified from the first text segment 200 that states “Awesome food at Spinachilini's”, as illustrated in FIG. 2A. The first column lists one or more message features determined from the example message, including sender information represented by “From: <Friend A>”, which may be determined from the “From” field 210 of the first message. The first column lists one or more recipients represented by “To: <Friend B>, <Friend C>, <Friend D>”, which may be determined from the “To” field 205 of the first message. The first column also lists time stamp data represented by “Sent on <Nov. 25, 2012> at <9:05 P.M.>”, which may be determined from the time stamp data 215 for the first message. Additional message features may be identified from the first text segment 200, such as “Awesome”, and “Awesome food”.

The second column lists event attributes associated with the example message, including a type of event such as “Dinner”; number of past user interactions with the event such as “Multiple visits”; the attendees of the event including “Friend A”, “Friend B”, “Friend C”, “Friend D”; an event location such as “Spinachilini's”, and one or more Ratings and/or reviews associated with the event.

Referring to FIG. 2C, a table illustrates an example of n-grams identified from an electronic message. Some aspects of the example in FIG. 2C may be described with reference to the group of electronic messages illustrated in FIG. 2A. The n-grams may be identified from the first text segment 200 illustrated in FIG. 2A. The first column includes the first text segment 200: “Awesome food at Spinachilini's”; and the second column lists one or more n-grams associated with the first text segment 200, including “Awesome”, “Awesome food”, “Spinachilini's”, “Awesome food Spinachilini's”, and “food Spinachilini's”. As described herein, in some implementations a stop word such as “at” may be removed from a determined n-gram.

Referring to FIG. 2D, a table illustrates another example of n-grams identified from an electronic message. Some aspects of the example in FIG. 2C may be described with reference to the group of electronic messages illustrated in FIG. 2A. The n-grams may be identified from the second text segment 230 illustrated in FIG. 2A. The first column includes the second text segment 230: “Tastes better each time”; and the second column lists one or more n-grams associated with the message, including “Tastes”, “better”, “Tastes better”, “each time”, and “better each time”, as determined from the second text segment 230 of the first message.

In some implementations the feature representation associated with a given message feature may be a feature vector. The components of the feature vector may include one or more of n-grams associated with the given message feature, other message features associated with the given message feature, syntactic and semantic features of the given message feature, and so forth. For example, a feature vector may include an n-gram, a timestamp, a sender, a recipient, and so forth. For example, the message may include a text segment such as: “Awesome food at Spinachilini's”. The message feature generation system 130 may determine one or more message features such as “From: <Friend A>”, “To: <Friend B>, <Friend C>,”, “Sent: <Nov. 25, 2012>”, “Awesome”, and “Awesome food”. Based at least in part on the one or more message features, the message feature generation system 130 may generate a feature vector such as
[Friend A, 11252012, Awesome, food, Awesome food].

In some implementations one or more components of the feature vector may include a feature vector. For example, the message feature generation system 130 may generate a first feature vector such as [Friend A; Friend B, Friend C], and utilize this to generate a second feature vector such as
[[Friend A; Friend B, Friend C], 11252012, Awesome, food, Awesome food].

In some implementations the feature representation may be based on the event attribute. For example, the message feature generation system 130 may determine one or more message features such as “From: <Friend A>”, “To: <Friend B>, <Friend C>,”, “Sent: <Nov. 25, 2012>”, “Awesome”, and “Awesome food”, and may additionally identify an event attribute such as Friend B did not go to Spinachilini's, whereas Friend A and Friend C did go. Accordingly, the message feature generation system 130 may generate a first feature vector such as [Friend A; Friend B, Friend C], a second feature vector such as [Friend A, Friend C], and utilize this to generate a third feature vector such as
[[Friend A; Friend B, Friend C], [Friend A, Friend C], Spinachilini, Awesome food].

A feature score may be associated with a given message feature of the one or more message features. The feature score may be based on the likelihood that the at least one user interacted with the event. The feature score for the given message feature is indicative of a likelihood that the at least one user will interact with another event associated with another message having the given message feature. In some implementations the feature score may be determined by the scoring system 150. For example, based on the likelihood that the user interacted with an event in the past, the user interaction determination system 140 may determine that message features such as “Awesome”, “Sure”, “Will be there”, “See you”, “Yup”, are associated with a high likelihood that the user will interact with the event, and/or one or more event attributes associated with the event.

On the other hand, based on the likelihood that the user interacted with an event attribute in the past, the user interaction determination system 140 may determine that message features such as “Perhaps”, “Maybe”, “Not sure”, “I'll pass”, “Nope”, are associated with a low likelihood that the user will interact with the event, and/or one or more event attributes associated with the event. Accordingly, the scoring system 150 may associate higher feature scores with the message features “Awesome”, “Sure”, “Will be there”, “See you”, and “Yup”, and may associate lower feature scores with the message features such as “Perhaps”, “Maybe”, “Not sure”, “I'll pass”, and “Nope”.

In some implementations the feature score for the given message may be additionally and/or alternatively based on user interaction data. For example, based on timestamp data, a message feature associated with a more recent message may be associated with a higher feature score. Also, for example, the feature score may be based a weighting of one or more aspects of the user interaction data. For example, the weighting may be based on frequency data related to whether the message was opened, read, forwarded, responded to, categorized or stored in a particular location, deleted, removed and/or deleted without review by an automated program (e.g., a spam filter). Additional and/or alternate weighting of one or more aspects of the user interaction data may be utilized to determine the feature score, including weightings based on recency of interaction with the message, quickness of response or processing of messages from a particular user or on a particular topic, frequency of interaction with messages on the same topic or from a user or group of users, and so forth. As indicated herein, the message feature determination system 130 may utilize the user interaction data to provide signals to the user interaction determination system 140 and/or the scoring system 150 to determine the feature score of a feature representation.

In some implementations the feature score for the given message may be associated with one or more event attributes associated with the event. For example, a first feature score may be associated with an event location and a second feature score may be associated with the one or more additional users at the event location. For example, the message feature “Maybe” associated with an event location may be indicative of high likelihood that the user will interact with the event location, whereas the message feature “Maybe” associated with one or more additional users may be indicative of low likelihood that the user will interact with the one or more additional users. Also, for example, the message feature “Maybe” associated with an event location and one or more additional users may be indicative of high likelihood that the user will interact with the event location and the one or more additional users; whereas the message feature “Maybe” associated with a day and time may be indicative of low likelihood that the user will interact with the day and the time. In some implementations the feature score for the given feature may be determined as a composite of the feature scores associated with the one or more event attributes. For example, the feature score for the given feature may be determined as a linear combination of the first and second feature scores, a weighted sum of the first and second feature scores, and so forth.

As another example, based on the likelihood that the user interacted with an event, the user interaction determination system 140 may determine that a message feature such as “Sure”, when followed by a message feature such as “see you then” is associated with a high likelihood that the user will interact with the event; whereas the message feature such as “Sure”, when followed by a message feature such as “lets see” is associated with a low likelihood that the user will interact with the event. The message feature determination system 130 may generate feature vectors [Sure, see you then] and [Sure, lets see]. Accordingly, the scoring system 150 may associate a higher feature score with the feature vector [Sure, see you then], and may associate a lower feature score with the feature vector [Sure, lets see].

In some implementations the feature score may be based on a contextual usage of the given message feature with respect to other message features. For example, the feature score may be based on identifying a semantic similarity score between the given message feature and another message feature. Also, for example, the feature score may be based on a context-based matching score between the given message feature and another message feature.

In some implementations the feature score for the given message feature may be based on the likelihood that the user interacted with the event location. For example, the message may include a text segment such as: “Awesome food at Spinachilini's”. The user interaction determination system 140 may access the content database 120 to determine that there is a high likelihood that the user interacted with the restaurant “Spinachilini's”. The message feature determination system 130 may determine a message feature “Awesome food”. Based at least on the determined likelihood and the determined message feature, the scoring system 150 may determine that the message feature “Awesome food” may be associated with a high likelihood that the user will interact with the restaurant “Spinachilini's”. As another example, the message may include a text segment such as: “Why sushi?”. The user interaction determination system 140 may access the content database 120 to determine that there is a low likelihood that the user interacted with the sushi restaurant “Mosaika”. The message feature determination system 130 may determine a message feature “why sushi”. Based at least on the determined likelihood and the determined message feature, the scoring system 150 may determine that the message feature “why sushi” may be associated with a low likelihood that the user will interact with the sushi restaurant “Mosaika”.

In some implementations the event attribute may represent a group of event attributes determined from a plurality of messages, and the feature score for the given message feature may be based on the likelihood that the user interacted with the group of event attributes. For example, X may be representative of a group of restaurants, say sushi restaurants, Italian restaurants, Indian restaurants, restaurants in downtown, and so forth. The message feature determination system 130 may determine a message feature such as “why <X>?” in the plurality of messages. For example, the message feature determination system 130 may determine a first message feature such as “why <sushi restaurant A>?” in a first message, and a second message feature such as “why <sushi restaurant B>?” in a second message. The first message feature may be associated with a first feature score, and the second message feature may be associated with a second feature score. Statistical analysis of the feature scores associated with the message feature “why <X>?”, where X is representative of sushi restaurants, may indicate a low likelihood that the user interacted with the group of restaurants X. Based at least on such determinations the scoring system 150 may determine that the message feature “why <X>?” in an additional message may be associated with a low likelihood that the user will interact with a restaurant from the group of restaurants X.

In some implementations a component weight may be associated with one or more components of the feature representation, and the feature score may be based on the component weight. In some implementations at least one message feature of the one or more message features may be weighted. In some implementations the weights may be utilized to give additional weighting to message features that are related to the user and/or the event attribute. For example, if an n-gram is included in the electronic message that the user has read, shared (e.g., forwarded or posted), or otherwise processed, the feature score of that n-gram may be determined (e.g., increased). In some implementations a database such as content database 120 may include frequency data associated with one or more of the message features, and one or more of the message features may be weighted based on such frequency data. Frequency data may include data related to how many times a message feature utilized in an electronic message by the user. In some implementations the frequency data may be based on a community of users. Also, for example, processed message information may be used to determine whether the user ever communicated with another user, how frequently the user communicated with another user, or how recently the user communicated with another user.

In some implementations the user may be a collection of users and the feature scores may be determined for the collection of users. For example, the collection of users may be identified as users in a first geographical location. Based on the likelihood that a collection of users interacted with an event, the user interaction determination system 140 may determine that a message feature such as “in 5 minutes” is associated with a high likelihood that the collection of users associated with a first geographical location will interact with the event; whereas the message feature such as “in half an hour” is associated with a high likelihood that the collection of users associated with a second geographical location will interact with the event. Accordingly, the scoring system 150 may associate a higher feature score with the message feature “in 5 minutes” for the users in the first geographical location, and may associate a higher feature score with the message features “in half an hour” for the users in the second geographical location.

The feature score may be associated with the given message feature. In some implementations message features and their associated feature scores may be stored in a message database. For example, the database may include nodes for one or more users, electronic messages, message features, events, event attributes, and/or other nodes. The nodes may be linked together to represent associations. For example, a user may be linked to an electronic message generated by the user, and the electronic message and the user may be linked to one or more message features of the electronic message. The message features, may in some implementations, be linked to feature representations. Also, for example, the user, the electronic message, and the one or more message features may all be linked to an event attribute. The links between the one or more message features and the event attribute may be associated with the respective feature scores of the one or more message features. In some implementations a collection of users may be represented by a node in the database, and the collection of users may be associated with electronic messages, message features, feature scores, event attributes, and so forth.

In some implementations an additional event and/or additional event attribute associated with an additional message of the user may be identified, along with one or more additional message features of the additional message. For example, the user may generate an additional message associated with planning a dinner with friends. The additional message may include an additional event such as “dinner with friends”, and one or more additional message features such as “c u”, “in 5 minutes”, “starving”, and so forth. In some implementations a feature vector such as [c u, in 5 minutes, starving] may be generated based on the additional message feature “c u”.

The additional message feature may be matched to a given message feature. For example, the additional message feature represented by the vector [c u, in 5 minutes, starving] may be matched to a given message feature in the one or more databases, such as the vector [see you, in half an hour, am hungry]. The user interaction determination system 140 may access content database 120 to determine the feature score associated with the given message feature represented by the vector [see you, in half an hour, am hungry]. For example, the given message feature represented by the vector [see you, in half an hour, am hungry] may be associated with a feature score indicative of high likelihood that the user will interact with another event associated with another message having the given message feature. Based on the feature score, a likelihood that the user will interact with the additional event may be determined. For example, based on the matching, the additional message feature represented by the vector [c u, in 5 minutes, starving] is associated with a high likelihood that the user will interact with the additional event “dinner with friends”.

In some implementations content related to the additional event may be provided based on the likelihood that the at least one user will interact with the additional event. For example, content related to the additional event attribute “dinner with friends” may include the venue for the dinner, directions to the restaurant, a telephone number to make reservations at the restaurant, a confirmation electronic message sent to friends identified by the additional event attribute “dinner with friends”, a menu of the restaurant, a reminder as to the menu selections previously sampled by the user, and so forth. In some implementations such content may be provided directly to the user. In some implementations such content may be provided to one or more components of a computer network that may support computer applications, such as applications that provide responses to search queries issued by the user, applications that provide suggestions to the user, applications that provide task related support to the user, and so forth. In some implementations providing content includes providing an indication to the at least one user that the additional message pertains to an event.

The client device 110, the content database 120, the message feature determination system 130, the user interaction determination system 140, and/or the scoring system 150, may each include memory for storage of data and software applications, a processor for accessing data and executing applications, and components that facilitate communication over the communication network 101. The content database 120, the message feature determination system 130, the user interaction determination system 140, and/or the scoring system 150 may be implemented in hardware, firmware, and/or software running on hardware. For example, one or more of the systems may be implemented in one or more computer servers.

The client devices 110 may execute applications, such as web browsers executing on client device 110 that allow users to generate and/or receive electronic messages. For example, the client device 110 may forward, to the message feature determination system 130, an additional message received by the user. Also, for example, the user may view an additional message via the client device 110 and the additional message may be forwarded (prior to, simultaneous with, or after viewing) to the message feature determination system 130 by an e-mail server and/or other component. In some implementations, the message feature determination system 130 may be a component of an e-mail server. The message feature determination system 130 may identify an additional message feature of a received additional message that pertains to an additional event. Based on the additional message feature, the user interaction determination system 140 may identify a given message feature that matches the additional message feature. For example, the user interaction determination system 140 may access the content database 120 of stored message features and identify a given message feature that matches the additional message feature. The user interaction determination system 140 may further identify a feature score associated with the given message feature in the content database 120. Based on the feature score associated with the given message feature, the user interaction determination system 140 may determine a likelihood that the user will interact with the additional event of the message. In some implementations the user interaction determination system 140 and/or other component may provide content related to the additional event based on the likelihood (e.g., when the likelihood satisfies a threshold). In some implementations such content may be provided to the at least one user via the client device 110 in a form that can be presented to the at least one user.

In some implementations providing the content may include providing an indication to the at least one user that the additional message pertains to an event. For example, one or more aspects of the message may be flagged as pertaining to an event. For example, the message as a whole may be indicated as pertaining to an event, those aspects of the message related to the message features may be underlined, highlighted, or otherwise indicated as pertaining to an event, and/or other aspects of the message may be indicated as pertaining to an event such as identified event attributes of the message. Also, for example, a pop-up or other notification may be provided that indicates the message pertains to an event. In some implementations providing the content may include providing additional information related to the event. Additional information related to the event may include, for example, a menu of an event restaurant, a reminder as to the menu selections previously sampled by the user at an event restaurant, directions to an event, suggestions of places to visit before and/or after an event, etc. Additional and/or alternative content related to the event may be provided such as, for example, query suggestions, search results, etc. that are influenced based on the event and the determined likelihood for the event. For example, query suggestions related to one or more event attributes of the event may be promoted to the user based on determining a likelihood, based on message features, that is indicative of a high probability that the user will attend the event.

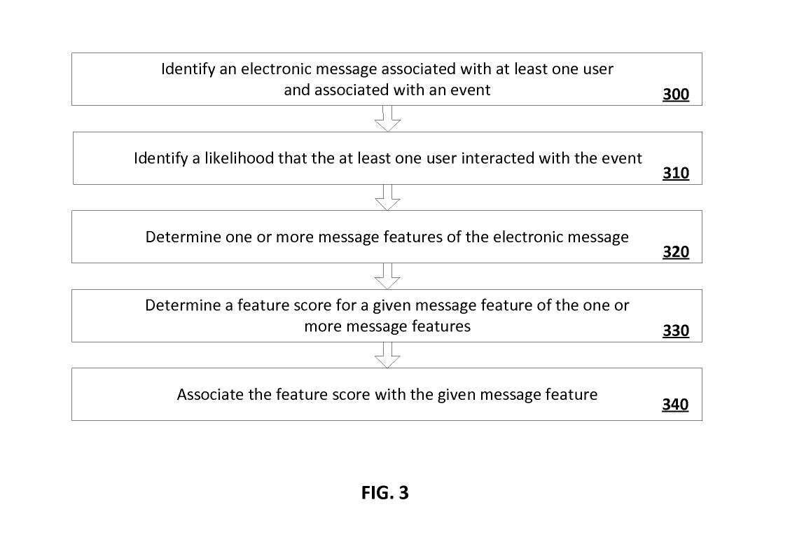

Referring to FIG. 3, a flow chart illustrates an example method of determining feature scores for message features. Other implementations may perform the steps in a different order, omit certain steps, and/or perform different and/or additional steps than those illustrated in FIG. 3. For convenience, aspects of FIG. 3 will be described with reference to a system of one or more computers that perform the process. The system may include, for example, the content database 120, the message feature determination system 130, the user interaction determination system 140, and/or the scoring system 150 of FIG. 1.

At step 300, an electronic message associated with at least one user and associated with an event may be identified. The electronic message may include one or more of email communications, posts on social networking platforms, instant messages, chats, message board postings, social media postings, and so forth. In some implementations the message feature determination system 130 identifies the electronic message. In some implementations a group of electronic messages may be identified. In some of those implementations the group of electronic messages is a grouping of related messages. In some implementations, the group of electronic messages may be identified by determining associations between the messages of the group such as the messages being part of the same thread, the messages sharing similar recipients, the messages being generated by an individual and sent to one or more similar individuals, the messages having similar subject lines, the messages having similar terms in bodies of the messages, and/or a relationship of the messages to a task and/or an event. In some implementations, the group of electronic messages may be a linear continuation of messages between two or more users.

For each identified electronic message, one or more event attributes of the event may be determined. One or more natural language processing techniques may be optionally utilized to identify the one or more event attributes from the message. In some implementations the event attributes may include, for example, an event location, invitees to the event, likely visitors to the event location, a date of the event, a time of the event, a dress code for the event, and/or a type of event. For example, the type of event may be a “game day” at an event location characterized as a “sports bar”, with invitees including “college alumni”, and a dress code for the event may be “college colors”. As another example, the type of event may be a “hiking” at an event location identified as “Mt. ABC”, and a dress code for the event may be identified as “hiking attire”. Also, for example, the type of event may be a “field trip” at an event location identified as the “zoo”, and a dress code for the event may be identified as “winter jackets, caps, and gloves”.

In some implementations the event attribute may include an event location identifier. For example, an event location identifier may include one or more of a physical address of the event location, name of the event location (e.g., Spinachilini's), telephone number associated with the event location, GPS coordinates associated with the event location, broadcast name for a Wi-Fi network associated with the event location, and so forth. In some implementations the message feature determination system 130 may identify one or more entities appearing in the group of email messages and utilize the one or more entities to identify an event location identifier. For example, one or more of the electronic messages may include the term “Spinachilini's”, and the message feature determination system 130 may identify the entity associated with “Spinachilini's” as an event location identifier.

At step 310, a likelihood that the at least one user interacted with the event may be identified. In some implementations the user interaction determination system 140 may access a database such as content database 120 to retrieve information related to the likelihood that the user interacted with the event in the past. For example, a stored entry in a database and/or index personal to the user may map a likelihood that the user interacted with the event. For example, the entry may include a determined probability the user interacted with Restaurant A, a status identifier indicating the user interacted with Restaurant A, and/or other identifier indicating the entry is related to a location likely interacted with by the user. Based on conventional and/or other searching techniques, the stored entry may be determined to be relevant to the user. For example, the content database 120 may include an entry associated with the user and the event. For example, an entry associated with the user may include an identifier of the likelihood and an identifier of at least one of the event attributes associated with the event. For example, in implementations where the likelihood is a binary “true” or “false”, the entry may include an identifier of the likelihood that indicates an event location was visited by the user.

At step 320, one or more message features of the electronic message may be determined. The message features may be determined from, for example, a subject line of the message, a body of the message, recipient fields of the message, hyperlinks of the message, metadata of the message, and/or one or more additional or alternative components of a message. The message features of the electronic message may include some or all of the content of the electronic message, and/or any information that may be derived from the content of the message. For example, the one or more message features of the electronic message may include but are not limited to: words, terms or phrases in the electronic message; URLs in the electronic message; number of URLs in the electronic message; timestamps of the electronic message; a user's interest (or lack of interest) in topics or subjects based on content of the electronic message; whether the content of the electronic message is spam; and/or any other information based on content analysis of the messages. For example, the body of the messages may be processed by another module to identify topics of interest and/or topics not interesting to the user.

In some implementations determining the one or more message features may include determining one or more n-grams from the message. An n-gram is a sequence of n consecutive terms appearing in a text segment. For example, the message may include a sentence: “Awesome food at Spinachilini's”. The n-grams in the sentence may be identified as “Awesome”, “Awesome food”, “Spinachilini's”, “Awesome food Spinachilini's”, and “food Spinachilini's”, and so forth. As described herein, in some implementations a stop word such as “at” may be removed in determining an n-gram.

At step 330, a feature score for a given message feature of the one or more message features may be determined. The feature score may be based on the likelihood that the at least one user interacted with the event, and the feature score may be indicative of a likelihood that the at least one user will interact with another event associated with another message having the given message feature. In some implementations the feature score may be determined by the scoring system 150. For example, based on the likelihood that the user interacted with an event attribute in the past, the scoring system 150 may determine that message features such as “Awesome”, “Sure”, “Will be there”, “See you”, “Yup”, are associated with a high likelihood that the user will interact with the event attribute. On the other hand, based on the likelihood that the user interacted with an event attribute in the past, the scoring system 150 may determine that message features such as “Perhaps”, “Maybe”, “Not sure”, “I'll pass”, “Nope”, are associated with a low likelihood that the user will interact with the event attribute. Accordingly, the scoring system 150 may associate feature scores more indicative of likelihood of interaction with the message features “Awesome”, “Sure”, “Will be there”, “See you”, and “Yup”, and may associate feature scores less indicative of likelihood of interaction with the message features such as “Perhaps”, “Maybe”, “Not sure”, “I'll pass”, and “Nope”.

In some implementations the feature score for the given message feature may be based on the likelihood that the user interacted with the event attribute. For example, the message may include a text segment such as: “Awesome food at Spinachilini's”. The user interaction determination system 140 may access the content database 120 to determine that there is a high likelihood that the user interacted with the restaurant “Spinachilini's”. The message feature determination system 130 may determine a message feature “Awesome food”. Based at least on the determined likelihood and the determined message feature, the scoring system 150 may determine that the message feature “Awesome food” may be associated with a high likelihood that the user will interact with another event associated with another message having the given message feature.

At step 340, the feature score may be associated with the given message feature. In some implementations message features and their associated feature scores may be stored in a message database. For example, the database may include nodes for one or more users, electronic messages, message features, events, event attributes, and so forth. The nodes may be linked together to represent associations. For example, a user may be linked to an electronic message generated by the user, and the electronic message and the user may be linked to one or more message features of the electronic message. The message features, may in some implementations, be linked to feature representations. Also, for example, the user, the electronic message, and the one or more message features may all be linked to an event attribute. The links between the one or more message features and the event attribute may be associated with the respective feature scores of the one or more message features. In some implementations a collection of users may be represented by a node in the database, and the collection of users may be associated with electronic messages, message features, feature scores, event attributes, and so forth.

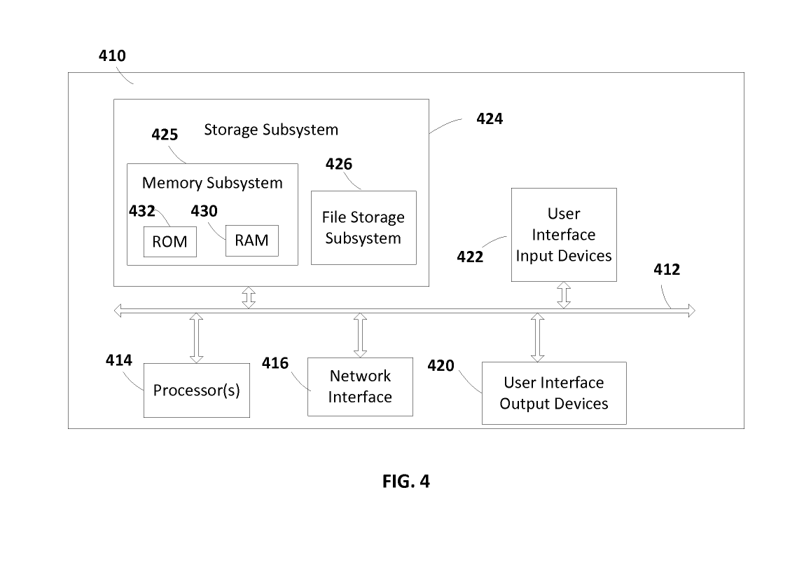

FIG. 4 is a block diagram of an example computer system 410. Computer system 410 typically includes at least one processor 414 which communicates with a number of peripheral devices via bus subsystem 412. These peripheral devices may include a storage subsystem 424, including, for example, a memory subsystem 425 and a file storage subsystem 426, user interface input devices 422, user interface output devices 420, and a network interface subsystem 416. The input and output devices allow user interaction with computer system 410. Network interface subsystem 416 provides an interface to outside networks and is coupled to corresponding interface devices in other computer systems.

User interface input devices 422 may include a keyboard, pointing devices such as a mouse, trackball, touchpad, or graphics tablet, a scanner, a touchscreen incorporated into the display, audio input devices such as voice recognition systems, microphones, and/or other types of input devices. In general, use of the term “input device” is intended to include all possible types of devices and ways to input information into computer system 410 or onto a communication network.

User interface output devices 420 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computer system 410 to the user or to another machine or computer system.

Storage subsystem 424 stores programming and data constructs that provide the functionality of some or all of the modules described herein. For example, may include the logic to determine the one or more message features. As another example, the storage subsystem 424 may include the logic to determine the feature score associated with a message feature of the one or more message features.

These software modules are generally executed by processor 414 alone or in combination with other processors. Memory 425 used in the storage subsystem can include a number of memories including a main random access memory (RAM) 430 for storage of instructions and data during program execution and a read only memory (ROM) 432 in which fixed instructions are stored. A file storage subsystem 426 can provide persistent storage for program and data files, and may include a hard disk drive, a floppy disk drive along with associated removable media, a CD-ROM drive, an optical drive, or removable media cartridges. The modules implementing the functionality of certain implementations may be optionally stored by file storage subsystem 426 in the storage subsystem 424, or in other machines accessible by the processor(s) 414.

Bus subsystem 412 provides a mechanism for letting the various components and subsystems of computer system 410 communicate with each other as intended. Although bus subsystem 412 is shown schematically as a single bus, alternative implementations of the bus subsystem may use multiple busses.

Computer system 410 can be of varying types including a workstation, server, computing cluster, blade server, server farm, or any other data processing system or computing device. Due to the ever-changing nature of computers and networks, the description of computer system 410 depicted in FIG. 4 is intended only as a specific example for purposes of illustrating some implementations. Many other configurations of computer system 410 are possible having more or fewer components than the computer system depicted in FIG. 4.

While several implementations have been described and illustrated herein, a variety of other means and/or structures for performing the function and/or obtaining the results and/or one or more of the advantages described herein may be utilized, and each of such variations and/or modifications is deemed to be within the scope of the implementations described herein. More generally, all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific implementations described herein. It is, therefore, to be understood that the foregoing implementations are presented by way of example only and that, within the scope of the appended claims and equivalents thereto, implementations may be practiced otherwise than as specifically described and claimed. Implementations of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

What is claimed is:

1. (canceled)

2. A method implemented by one or more processors, comprising:
identifying a group of electronic messages that include a message sent by a first user to a second user and a reply electronic message that is a reply by the second user to the message;
determining, based on one or more of the electronic messages of the group, event attributes of an event referenced by the one or more electronic messages of the group, the event attributes each identifying a characteristic of the event and including:
an event location of the event, and
a time of the event;
determining a likelihood that the second user interacted with the event location at the time of the event, wherein determining the likelihood that the second user interacted with the event location at the time of the event is based on comparing location data of the second user to one or more of the event attributes;
determining at least one reply message feature based on content of the reply message, wherein the reply message feature is in addition to any of the event attributes;
determining a score for the reply message feature based on the determined likelihood that the second user interacted with the event location at the time of the event;
associating the score with the reply message feature;
after determining the score for the reply message feature and associating the score with the reply message feature:
identifying an additional group of additional electronic messages that are associated with an additional event having an additional event location;
determining that the reply message feature matches an additional reply message feature of an additional reply message of the additional electronic messages of the additional group;
determining, based on the score of the reply message feature, an interaction likelihood that a sender of the additional reply message will interact with the additional event, the determining being based on the score of the reply message feature in response to determining that reply message feature matches the additional reply message feature; and
providing, to a client computing device of the sender and based on the interaction likelihood, additional event content related to the additional event.

3. The method of claim 2, wherein the reply message feature includes an n-gram in the body of the reply message.

4. The method of claim 2, wherein providing the additional event content related to the additional event comprises providing query suggestions or search results influenced by the interaction likelihood.

5. The method of claim 2, wherein providing the additional event content includes providing an indication to the recipient that at least one of the electronic messages of the additional group pertains to the additional event.

6. The method of claim 2, wherein the second user and the sender are different users.

7. A method implemented by one or more processors, comprising:
identifying a group of electronic messages that include a message sent by a first user to a second user and a reply message that is a reply by the second user to the message;
determining an event location of an event referenced by the group of electronic messages;
determining, based on the event location and location data of the second user, a likelihood that the second user interacted with the event location;
determining at least one interaction feature based on one or more interactions of the second user with one or more of the electronic messages of the group;
determining a score for the interaction feature based on the determined likelihood that the second user interacted with the event location;
associating the score with the interaction feature;
after determining the score for the interaction feature and associating the score with the interaction feature:
identifying an additional group of additional electronic messages that are associated with an additional event having an additional event location;
determining that the interaction feature matches an additional interaction feature, the additional interaction feature being based on one or more interactions of a given user with one or more of the additional electronic messages of the additional group;
determining, based on the score, an interaction likelihood that the given user will interact with the additional event, the determining being based on the score in response to determining that the interaction feature matches the additional interaction feature; and
providing, to a client computing device of the given user and based on the interaction likelihood, additional event content related to the additional event.

8. The method of claim 7, wherein the interaction feature is based on user interaction data indicating how the second user interacted with the electronic message.

9. The method of claim 7, wherein the interaction feature is based on user interaction data indicating quickness of generating the reply electronic message in response to the first electronic message.

10. The method of claim 7, wherein providing the additional event content related to the additional event comprises providing query suggestions or search results influenced by the interaction likelihood.

11. The method of claim 7, wherein providing the additional event content includes providing an indication to the recipient that at least one of the electronic messages of the additional group pertains to the additional event.

12. The method of claim 7, wherein the second user and the given user are different users.

13. The method of claim 7, further comprising determining a time of the event.

14. The method of claim 13, wherein determining the likelihood that the second user interacted with the event location comprises determining the likelihood that the second user interacted with the event location at the time of the event.

15. A method implemented by one or more processors, comprising:
identifying a group of electronic messages that include a message sent by a first user to a second user and a reply message that is a reply by the second user to the electronic message;
determining, based on one or more of electronic messages of the group, event attributes of an event referenced by the one or more electronic messages of the group, the event attributes each identifying a characteristic of the event and including:
an event location of the event, and
a time of the event;
determining a likelihood that the second user interacted with the event location at the time of the event, wherein determining the likelihood that the second user interacted with the event location at the time of the event is based on comparing location data of the second user to one or more of the event attributes;
determining one or more message features, including at least one of:
a reply message feature based on content of the reply message; and
a user interaction feature based on one or more interactions of the second user with one or more of the electronic messages of the group;
determining a score for the one or more message features based on the determined likelihood that the second user interacted with the event location at the time of the event;
associating the score with the one or more message features;
after determining the score for the one or more message features and associating the score with the one or more message features:
identifying an additional group of additional electronic messages that are associated with an additional event having an additional event location;
determining that the one or more message features match one or more additional message features of the additional electronic messages of the additional group;
determining, based on the score for the one or more message features, an interaction likelihood that at least one recipient of one or more of the additional electronic messages will interact with the additional event, the determining being based on the score of the reply message feature in response to determining that the one or more message features match the one or more additional reply message features; and
providing, to a client computing device of the recipient and based on the interaction likelihood, additional event content related to the additional event.

16. The method of claim 15, wherein determining the one or more message features comprises determining both of: the reply message feature and the user interaction feature.

17. The method of claim 16, wherein the interaction feature is based on user interaction data indicating quickness of generating the reply electronic message in response to the first electronic message.

18. The method of claim 16, wherein the reply message feature includes an n-gram in the body of the reply message.

19. The method of claim 15, wherein providing the additional event content related to the additional event comprises providing query suggestions or search results influenced by the interaction likelihood.

20. The method of claim 15, wherein providing the additional event content includes providing an indication to the recipient that at least one of the electronic messages of the additional group pertains to the additional event.
